(19) United States
(12) Patent Application Publication
(10) Pub. No.: US 2006/0186608 A1
(43) Pub. Date: Aug. 24, 2006

(54) Weather strip with cushion member

(76) Inventors: Yasuhiro Morihara, Hiroshima-ken (JP); Koso Deguchi, Hiroshima-ken (JP)

Correspondence Address: FLYNN THIEL BOUTELL & TANIS, P.C., 2026 RAMBLING ROAD, KALAMAZOO, MI, 49008-1631, US

(21) Appl. No.: 11/312,025

(22) Filed: Dec. 20, 2005

(30) Foreign Application Priority Data
Feb. 10, 2005 (JP) 2005-034346

(51) Int. Cl. F16J 15/02

(52) U.S. Cl. 277/644

(57) ABSTRACT

There is provided a weather strip for an automobile with a cushion member which comprises a die molded portion. The die molded portion comprises a weather strip main body and a protruding cushion member which is integrally molded with the weather strip main body. The cushion member comprises a cavity for a purpose of absorbing a mechanical shock which is produced at a time a door is closed. The die molded portion is formed with a soft material. The cavity is filled with a cushion element which is made of a hard material.

### BACKGROUND OF THE INVENTION

This invention relates to a weather strip for an automobile installed, for example, to a door panel of the automobile, comprising a protruding cushion member in a die molded portion thereof for a purpose of absorbing a mechanical shock produced at a time the weather strip makes a resilient contact with a body of the automobile.

As illustrated in FIGS. 1 and 2, there has been a weather strip 20 installed to a door 1 of an automobile, comprising a protruding cushion member 24, besides a lip member 23 and a hollow seal member 24, for a purpose of absorbing a mechanical shock produced at a time the door is closed as well as for absorbing a door rattle produced while driving. This type of weather strip 20 is installed, for example, to an automobile comprising a front door and a rear door installed in a double door style, in which a center pillar is excluded.

The conventional weather strip 20 described above, comprising the protruding cushion member 22 in the die molded portion 21 thereof, is entirely formed with a hard material including the protruding cushion member 22 in order to fully satisfy the buffer effect.

As the entire portion of the die molded portion 21 is formed with the hard material, the buffer effect as well as a prevention of a vibration rattle of a door while driving is fully satisfied by the protruding cushion member 22 since the hard material is provided with an adequate rigidity. However, there is a problem in this conventional weather strip, that is, the lip member 23 being provided for a purpose of a sealing is unable to perform the sealing satisfactorily, as the lip member 23 is formed with the hard material as well.

### SUMMARY OF THE INVENTION

The invention has been invented to overcome such problem, and therefore, it is an object of this invention to provide a weather strip for an automobile comprising a die molded portion which performs a satisfactory buffer effect and a satisfactory prevention of a vibration rattle of a door while driving by a protruding cushion member, as well as a satisfactory sealing effect by a lip member, both provided to the die molded portion.

The invention will be described referring to FIGS. 1, 3 and 4. A weather strip for an automobile with a cushion member according to a first aspect of the invention comprises a die molded portion 11. The die molded portion 11 comprises a weather strip main body 12 and a protruding cushion member 14 which is integrally molded with the weather strip main body 12. The cushion member 14 comprises a cavity 15 for a purpose of absorbing a mechanical shock which is produced at a time a door is closed. The die molded portion 11 is formed with a soft material. The cavity 15 is filled with a cushion element 16 which is made of a hard material.

A weather strip for an automobile with a cushion member according to a second aspect of the invention comprises a die molded portion 11. The die molded portion 11 comprises a weather strip main body 12 and a protruding cushion member 14 which is integrally molded with the weather strip main body 12. The weather strip main body 12 is installed to an attaching portion 1 such as a door panel. The cushion member 14 comprises a cavity 15 in a side of the attaching portion 1 for a purpose of absorbing a mechanical shock which is produced at a time a door is closed and making a resilient contact with a contacting portion 2, e.g., a body panel. The die molded portion 11 is formed with a soft material. The cavity 15 is filled with a cushion element 16 which is made of a hard material.

A third aspect of the invention will be described referring to FIGS. 1, 3 and 5 to 8. A weather strip for an automobile with a cushion member according to a third aspect of the invention comprises a die molded portion 11. The die molded portion 11 comprises a weather strip main body 12 and a protruding cushion member 14 which is integrally molded with the weather strip main body 12. The cushion member 14 comprises a cavity 15 for a purpose of absorbing a mechanical shock which is produced at a time a door is closed. The die molded portion 11 is formed with a soft material. The cavity 15 is filled with a cushion element 16 made of a hard material. The cushion element 16 comprises a clip member 17 which is integrally formed with the element 16. The cushion element 16 is fixed in the cavity 15 by inserting the clip member 17 into a hole member 1 a formed in an attaching member 1 which the weather strip main body 12 is fixed to.

A weather strip for an automobile with a cushion member according to a fourth aspect of the invention comprises a die molded portion 11. The die molded portion 11 comprises a weather strip main body 12 and a protruding cushion member 14 which is integrally molded with the weather strip main body 12. The weather strip main body 12 is installed to an attaching portion 1, e.g., a door panel. The cushion member 14 comprises a cavity 15 in a side of the attaching portion 1 for a purpose of absorbing a mechanical shock which is produced at a time a door is closed while making a resilient contact with a contacting portion 2, e.g., a body panel. The die molded portion 11 is formed with a soft material. The cavity 15 is filled with a cushion element 16 which is made of a hard material. The cushion element 16 comprises a clip member 17 which is integrally formed with the element 16. The cushion element 16 is fixed in the cavity 15 by inserting the clip member 17 into a hole member la which is formed in an attaching member 1.

A weather strip for an automobile with a cushion member according a fifth aspect of the invention is such that the cushion element 16 and the clip member 17 in the third and fourth aspects of the invention are separately formed. The cushion element 16 comprises an attaching hole 16a. The clip member 17 is fixed to the cushion element 16 as it is inserted into the attaching hole 1 6a.

According the first aspect of the invention, the die molded portion 11 is formed with a soft material, so that it is good in adhesiveness, and that it performs an excellent sealing effect, while it hardly damages a coating painted on a body of the automobile. Further, the cushion element 16 made of a hard material is filled in the cavity 15 formed in the protruding cushion member 14, so that it is provided with a adequate rigidity, and that it is able to perform an excellent buffering effect.

According to the second aspect of the invention, the die molded portion 11, comprising the weather strip main body 12 which is installed to the attaching member 1, e.g., a door panel as well as the protruding cushion member 14 which is integrally formed with the main body 12, is formed with a soft material, while the cavity 15, formed in the protruding cushion member 14 in a side of the attaching member 1, is filled with the cushion element 16 made of a hard material, so that when a door is closed, the soft material makes an airtight contact with the contacting member 2, e.g., a body panel. Therefore, the sealing performance between the attaching member 1, e.g., a door panel and the contacting member 2, e.g., a body panel can be done excellently. Further, with the adequate rigidity the cushion element 16 is provided with, the buffer effect performed by the protruding cushion member 14 is also done excellently.

According to the third aspect of the invention, the die molded portion 11 is formed with a soft material, so that it is good in adhesiveness, and that it is able to perform an sealing effect excellently. Further, the cavity 15 of the protruding cushion member 14 is filled with the cushion element 16 made of a hard material, so that it, being provided with an adequate rigidity, is able to perform an excellent buffer effect. Moreover, the cushion element 16 is fixed to the attaching member 1 by inserting the clip member 17, which is integrally formed with the cushion element 16, into the hole member la formed in the attaching member 1, so that the cushion element 16 does not float from the attaching member 1 and it is firmly fixed thereto. Further, since the cushion element 16 is firmly fixed to the attaching member 1, not floating therefrom, neither water such as rain and car washing water invades into the interior of the automobile through that portion nor wind leaks from that portion. In case the cushion element 16 is not provided with the clip member 17, the cushion element 16 would float therefrom, and water might invade and wind might leaks through that portion.

According to the fourth aspect of the invention, the die molded portion 11, comprising the weather strip main body 12 to be installed to the attaching member 1, e.g., a door panel and the protruding cushion member 14 integrally formed with the main body 12, is formed with a soft material, while the cavity 15, formed in the protruding cushion member 14 in a side of the attaching member 1, is filled with the cushion element 16, so that when a door is closed, the soft material makes an airtight contact with the contacting member 2, e.g., a body panel. Therefore, the sealing performance between the attaching member, e.g., a door panel and the contacting member 2, e.g., a body panel can be done excellently. Further, with the adequate rigidity the cushion element 16 is provided with, the buffer effect performed by the protruding cushion member 14 can be done excellently as well. Moreover, the cushion element 16 is fixed as the clip member 17 integrally formed with the cushion element 16 is inserted into the hole member la formed in the attaching member 1, so that the cushion element 16 is prevented from floating, and that an invasion of water and a leakage of wind through that portion are both prevented properly.

According to the fifth aspect of the invention, the cushion element 16 and the clip member 17 in the third and fourth aspects of the invention are separately formed, and the clip member 17 is fixed to the cushion element 17 by inserting a part of the clip member 17 into the attaching hole 16a formed in the cushion element 16, so that there is such an advantage that both the cushion element 16 and the clip member 17 can be molded easily. Further, in this invention, the protruding cushion member 14 is to be formed in a hollow form, so that there is also such an advantage that molding material can be saved.

### BRIEF DESCRIPTION OF THE DRAWINGS

FIG. 1 is side elevation view showing an automobile installing a weather strip which comprises a die molded portion and a protrusion cushion member integrally formed therewith;

FIG. 2 is a perspective view showing a prior example;

FIG. 3 is a perspective view showing a preferred embodiment of the invention;

FIG. 4 is a sectional view along line X-X in FIG. 3 showing a first preferred embodiment of the invention;

FIG. 5 is a sectional view along line X-X in FIG. 3 showing a second preferred embodiment of the invention;

FIG. 6 is an elevation view showing a cushion element and a clip member according to a second preferred embodiment of the invention;

FIG. 7 is an elevation view showing another type of cushion element and clip member according to a second preferred embodiment of the invention;

and, FIG. 8 shows still another type of cushion element and clip member wherein (a) is an elevation view showing a state that they are attached, and (b) is an elevation section view in part showing a state before they are attached.

### DESCRIPTION OF THE PREFERRED EMBODIMENT

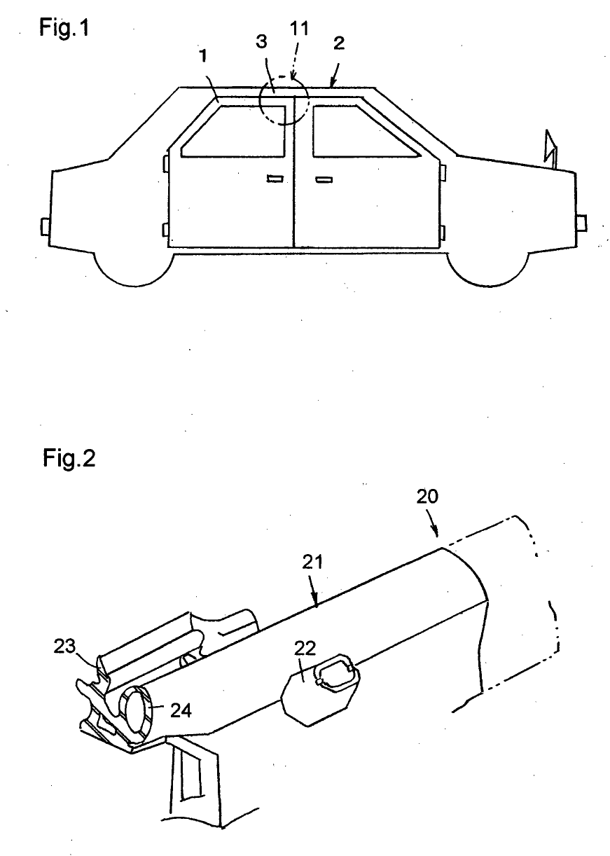

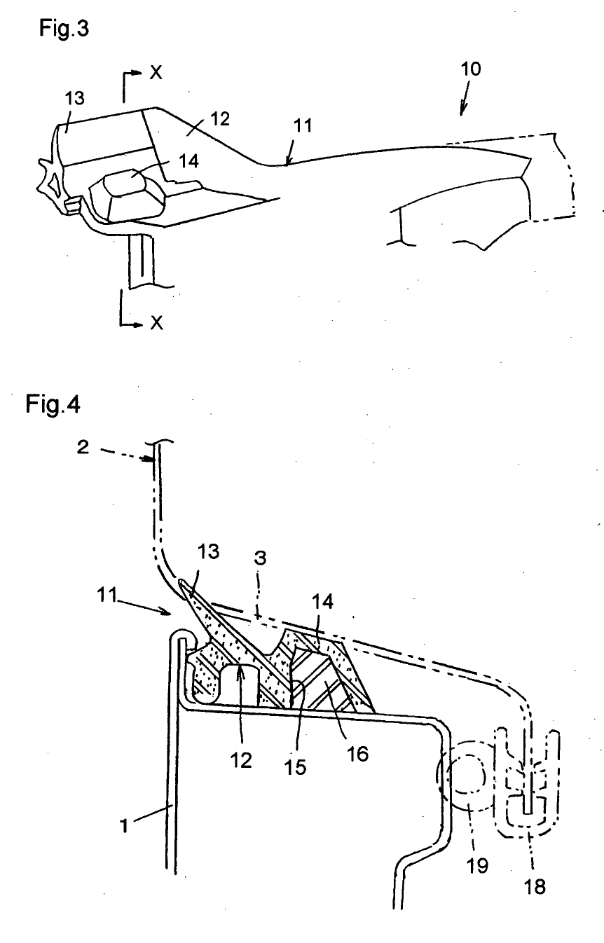

Referring to FIGS. 1, 3 and 4, a weather strip with a cushion member according to a first preferred embodiment of the invention will be described below. This weather strip 10 is installed to a rear door panel (an attaching member) 1 of an automobile which comprises a front door and a rear door installed in a double door style. This automobile does not comprise a center pillar. The weather strip 10 comprises a die molded portion 11 which includes a weather strip main body 12 and a protruding cushion member 14 integrally formed with the main body 12, and the die molded portion 11 is positioned in a front upper end portion of the rear door panel 1. The weather strip main body 12 comprises a lip member 13 which makes a resilient contact with a roof portion 3 of a body panel 2. The rear door is so called a first closing door in which the rear door is closed before the front door is closed, so that the weather strip 10 according to this embodiment makes a resilient contact with a body panel 2. The die molded portion 11 is continuously connected with an extrusion molded portion. Further, in an interior side of this weather strip 10, there is provided a seal member 19 for making a resilient contact with a door 1. The seal member 19 is integrally formed with a trim 18 which is installed to an opening edge of a body.

In this weather strip 10, a cavity 15 is formed in the protruding cushion member 15. The entire portion of the die molded portion 11 is formed with a soft material, e.g., sponge rubber, and the cavity 15 of the protruding cushion member 14 is filled with a hard material, a cushion element 16, made, for example, of solid rubber.

When the rear door comprising the weather strip 10 according to the embodiment is closed, the protruding cushion member 14 bumps into the body panel 2. Since the cavity 15 of the protruding cushion member 14 is filled with the cushion element 16 made of a hard material, the mechanical shock produced in this door closing operation is fully absorbed by the cushion element 16 which is provided with the adequate rigidity. Further, as the die molded portion 11 is formed with a soft material, it is good in adhesiveness, and the lip member 13 thereof can make an airtight resilient contact with the body panel 2, performing an excellent sealing effect.

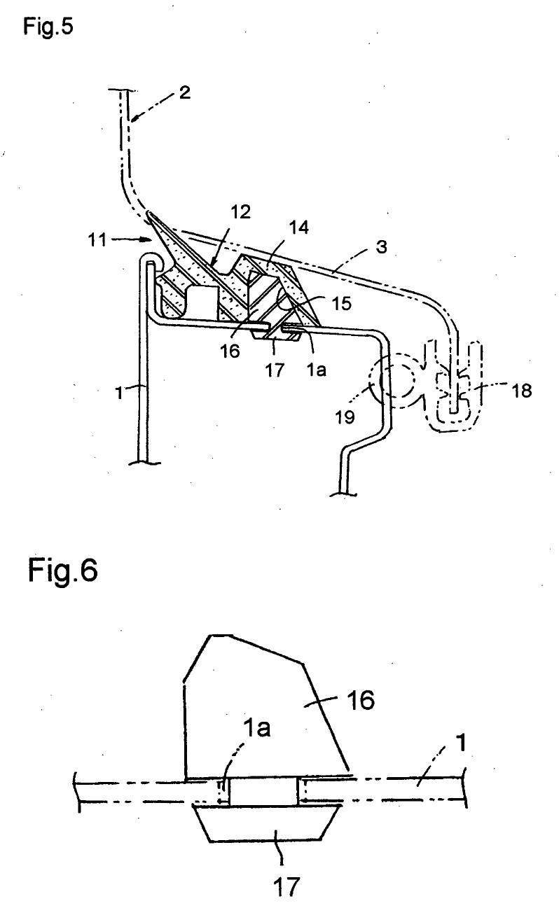

Referring to FIGS. 1, 3 and 5, a weather strip with a cushion member according to a second preferred embodiment of the invention will be described. According to the second embodiment, a clip member 17 is integrally formed with a cushion element 16, which is to be filled in a cavity 15 of a protruding cushion member 14, drooping from a bottom surface of the cushion element 16. The cushion element 16 is firmly fixed by inserting the clip member 17 into a hole member la formed in an attaching member 1.

In this structure, as the cushion element 16 is firmly fixed by inserting the clip member 17 integrally formed with the cushion element 16 into the hole member 1a of the attaching member 1, the cushion element 16 is prevented from floating from the attaching member 1. Therefore, an invasion of water through that portion can be prevented. Further, a generation of a wind noise is also prevented, which is produced by a leakage of wind through that portion.

Although, the weather strip 10 according to the preferred embodiment of the invention is installed to the rear door, and its lip member 13 and the protruding cushion member 14 are structured to make resilient contacts with the body panel 2, the invention is not limited to such structure, and it can be installed to a front door or a back door or other members, and have it make a resilient contact with a door panel or other members. Further, like the conventional art, the weather strip 10 may be provided with a hollow seal member 24 in the weather strip main body 12.

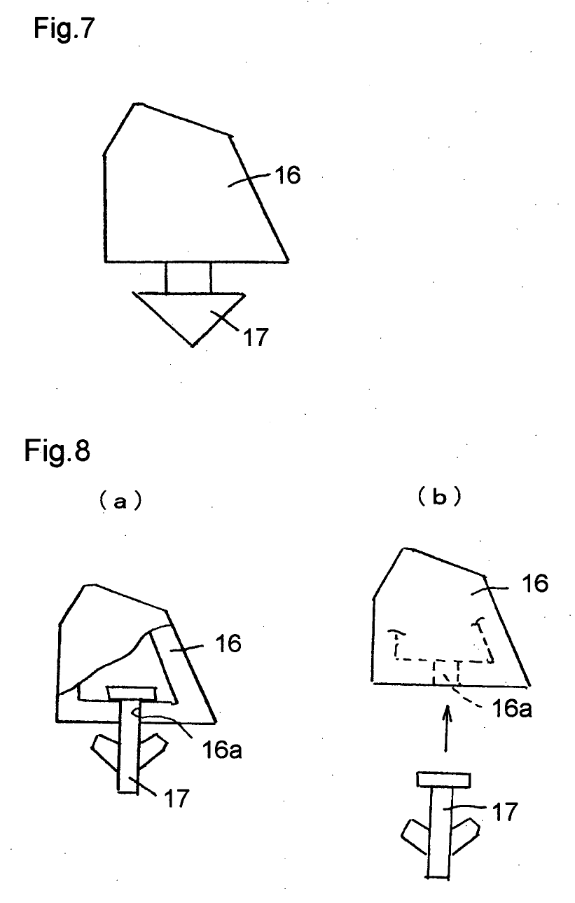

Like the cushion element 16, a shape of the clip member 17 according to the invention is not limited, and as illustrated in FIG. 6, it can be formed into an inverted trapezoid in front elevation, or as illustrated in FIG. 7, it can be formed into an inverted triangle in front elevation. Further, as illustrated in FIG. 8, it can be formed into a standard clip shape, and it can be fixed to a cushion element (cushion rubber) 16 by inserting a part thereof into a attaching hole 16a formed in the cushion element 16.

As a soft material used in this invention, there are sponge material, foamed thermoplastic elastomer, soft thermoplastic solid resin, soft thermoplastic solid elastomer, etc., and among them, it is preferable to use sponge rubber as the sponge material, and it is more preferable to use EPDM sponge rubber. A degree of hardness of the soft material is preferred to be 40 to 60 in ASCA hardness. Further, a degree of hardness of the soft material is preferred to be A20 to 30 in JIS (Japan Industrial Standard). As a hard material used in this invention, there are hard solid rubber, hard resin, hard thermoplastic elastomer, etc., and among them it is preferred to use the hard solid rubber, and it is more preferable to use EPDM solid rubber. A degree of hardness of the hard material is preferred to be A60 to 90 in JIS (Japan Industrial Standard).

A method for filling a cushion element into a cavity of a die molded portion 11 being formed with a soft material is as follows. In this method, the cushion element 16 may be integrally formed with a clip member 17, or a clip member 17 may be formed independently and may be fixed to a cushion element 16 thereafter.

(1) A die molded portion and a cushion element 16 are separately die molded, and they are integrated thereafter by means of adhesion.

(2) A cushion element 16 is die molded in advance, and it is fixed in a die when die molding a weather strip main body 12 and integrate it with the main body 12.

(3) A die molded portion made of a soft material and a cushion element 16 made of a hard material are integrally die molded at the same time in a same die.

The disclosure of Japanese Patent Application No. 2005-034346 filed Feb. 10, 2005 including specification, claims and drawings, is incorporated herein by reference.

1. A weather strip for an automobile with a cushion member comprising a die molded portion wherein, said die molded portion comprising a weather strip main body and a protruding cushion member integrally molded with said weather strip main body;
said cushion member comprising a cavity for absorbing a mechanical shock produced at a time a door is closed;
said die molded portion being formed with a soft material; and
said cavity being filled with a cushion element made of a hard material.

2. A weather strip for an automobile with a cushion member comprising a die molded portion wherein, said die molded portion comprising a weather strip main body and a protruding cushion member integrally molded with said weather strip main body;
said weather strip main body being installed to an attaching portion such as a door panel;
said cushion member comprising a cavity in a side of said attaching portion for absorbing a mechanical shock produced at a time a door is closed while making a resilient contact with a contacting portion such as a body panel;
said die molded portion being formed with a soft material; and
said cavity being filled with a cushion element made of a hard material.

3. A weather strip for an automobile with a cushion member comprising a die molded portion wherein,
said die molded portion comprising a weather strip main body and a protruding cushion member integrally molded with said weather strip main body;
said cushion member comprising a cavity for absorbing a mechanical shock produced at a time a door is closed;
said die molded portion being formed with a soft material;
said cavity being filled with a cushion element made of a hard material;
said cushion element comprising a clip member integrally formed therewith;
said cushion element being fixed in said cavity by inserting said clip member into a hole member formed in an attaching member; and
said weather strip main body being fixed to said attaching member.

4. A weather strip for an automobile with a cushion member comprising a die molded portion wherein,
said die molded portion comprising a weather strip main body and a protruding cushion member integrally molded with said weather strip main body;
said weather strip main body being installed to an attaching portion such as a door panel;
said cushion member comprising a cavity in a side of said attaching portion for absorbing a mechanical shock produced at a time a door is closed while making a resilient contact with a contacting portion such as a body panel;
said die molded portion being formed with a soft material;
said cavity being filled with a cushion element made of a hard material;
said cushion element comprising a clip member integrally formed therewith; and
said cushion element being fixed in said cavity by inserting said clip member into a hole member formed in an attaching member.

5. A weather strip for an automobile with a cushion member claimed in claim 3 wherein,
said cushion element and said clip member are separately formed;
said cushion element comprising an attaching hole; and
said clip member being fixed to said cushion element by being inserted into said attaching hole.
